(19) United States
(12) Patent Application Publication
(10) Pub. No.: US 2008/0100964 A1
(43) Pub. Date: May 1, 2008

(54) MAGNETIC RECORDING SYSTEM WITH MEDIUM HAVING ANTIFERROMAGNETIC-TO- FERROMAGNETIC TRANSITION LAYER EXCHANGE-COUPLED TO RECORDING LAYER

(75) Inventors: Eric Edward Fullerton, Morgan Hill, CA (US); Stefan Maat, San Jose, CA (US); Ian Robson McFadyen, San Jose, CA (US); Jan-Ulrich Thiele, Sunnyvale, CA (US)

Correspondence Address: THOMAS R. BERTHOLD, 18938 CONGRESS JUNCTION COURT, SARATOGA, CA, 95070, US

(73) Assignee: HITACHI GLOBAL STORAGE TECHNOLOGIES NETHERLANDS B.V., San Jose, CA (US)

(21) Appl. No.: 11/553,215

(22) Filed: Oct. 26, 2006

(51) Int. Cl. G11B 5/82; G11B 5/65

(52) U.S. Cl. 360/135; 428/836.1

(57) ABSTRACT

A magnetic recording disk drive has a bilayer recording medium of a high-anisotropy recording layer and an exchange-coupled antiferromagnetic-to-ferromagnetic (AF-F) transition layer. The transition layer has an AF-F transition temperature (T_{AF-F}) that decreases relatively rapidly with increasing applied magnetic field. Thus the transition layer has a transition field H_{AF-F}(T), which is the applied magnetic field required to transition the material from antiferromagnetic to ferromagnetic at temperature T without the need to heat the layer. At ambient temperature and in the absence of H_{W}, the transition layer is antiferromagnetic and the switching field H₀ of the bilayer is just the H₀ of the high-anisotropy recording layer, which is typically much higher than H_{W}. In the presence of the write field H_{W} the transition layer transitions from antiferromagnetic to ferromagnetic so that data can be written to the recording by the mere application of the write field H_{W} without the need to heat the transition layer or recording layer. The transition layer may be formed of Fe(RhM), where M is an element selected from V, Mn, Au and Ni.

### BACKGROUND OF THE INVENTION

1. Field of the Invention

The invention relates generally to magnetic recording systems, and more particularly to a magnetic recording disk drive having a medium with high thermal stability.

2. Background of the Invention

Magnetic recording disk drives use a thin film inductive write head supported on the end of a rotary actuator arm to record data in the recording layer of a rotating disk. The write head is patterned on the trailing surface of a head carrier, such as a slider with an air-bearing surface (ABS) to allow the slider to ride on a thin film of air above the surface of the rotating disk. The write head is an inductive head with a write pole or poles and a thin film electrical coil. When write current is applied to the coil, the write poles provide a localized magnetic field that magnetizes regions of the recording layer on the disk so that the magnetic moments of the magnetized regions are oriented into one of two distinct directions. The transitions between the magnetized regions represent the two magnetic states or binary data bits. The magnetic moments of the magnetized regions are oriented in the plane of the recording layer in longitudinal or horizontal recording, and perpendicular to the plane in vertical or perpendicular recording.

The magnetic material (or medium) for the recording layer on the disk is chosen to have sufficient coercivity such that the magnetized data bits are written precisely and retain their magnetization state until written over by new data bits. The data bits are written in a sequence of magnetization states to store binary information in the drive and the recorded information is read back with a use of a read head that senses the stray magnetic fields generated from the recorded data bits. Magnetoresistive (MR) read heads include those based on giant magnetoresistance (GMR), such as the spin-valve type of GMR head, and more recently magnetic tunneling, such as the tunneling MR (TMR) head. Both the write and read heads are kept in close proximity to the disk surface by the slider's ABS, which is designed so that the slider “flies” over the disk surface as the disk rotates beneath the slider.

As the areal data density (the number of bits that can be recorded on a unit surface area of the disk) increases, the magnetic grains that make up the data bits become smaller, which increases the possibility that they can be demagnetized simply from thermal instability or agitation within the magnetized bit (the so-called “superparamagnetic” effect). To avoid thermal instabilities of the stored magnetization, a minimal stability ratio of stored magnetic energy per grain, K_{U}V, to thermal energy, k_{B}T, of K_{U}V/k_{B}T>>60 will be required, where K_{U} and V are the magneto-crystalline anisotropy and the magnetic switching volume, respectively, and k_{B} and T are the Boltzman constant and absolute temperature, respectively. Because a minimum number of grains of magnetic material per bit are required to prevent unacceptable media noise, the switching volume V will have to decrease, and accordingly K_{U} will have to increase. However, increasing K_{U} also increases the switching field, H₀, which is proportional to the ratio K_{U}/M_{S}, where M_{S} is the saturation magnetization (the magnetic moment per unit volume). (The switching field Ho is the field required to reverse the magnetization direction, which for most magnetic materials is very close to but slightly greater than the coercivity or coercive field H_{C} of the material.) Obviously, H₀ cannot exceed the write field capability of the recording head, which is currently about 15 kOe for longitudinal recording, and about 20 kOe for perpendicular recording.

One approach to addressing this problem is thermal-assisted recording using a magnetic recording disk like that described in U.S. Pat. No. 6,834,026 B2. This disk has a bilayer medium of a high-coercivity, high-anisotropy ferromagnetic material like FePt as the storage or recording layer and a material like FeRh or Fe(RhM) (where M is Ir, Pt, Ru, Re or Os) as a “transition” layer that exhibits a transition or switch from antiferromagnetic to ferromagnetic (AF-F) at a transition temperature less than the Curie temperature of the high-coercivity, high-anisotropy material of the recording layer. The recording layer and the transition layer are ferromagnetically exchange-coupled when the transition layer is in its ferromagnetic state. To write data the bilayer medium is heated above the transition temperature of the transition layer with a separate heat source, such as a laser or electrically-resistive heater. When the transition layer becomes ferromagnetic, the total magnetization of the bilayer is increased, and consequently the switching field required to reverse a magnetized bit is decreased without lowering the anisotropy of the recording layer. The magnetic bit pattern is recorded in both the recording layer and the transition layer. When the media is cooled to below the transition temperature of the transition layer, the transition layer becomes antiferromagnetic and the bit pattern remains in the high-anisotropy recording layer. However, to utilize this type of disk the disk drive requires a separate heat source, such as a laser or an electrically resistive heater, that must be fabricated onto the slider, and additional control circuitry for controlling the timing and duration of the heat pulses. This necessarily increases the cost and complexity of the disk drive.

What is needed is a disk drive with a disk having a high-anisotropy recording layer/AF-F transition layer type of bilayer medium, but that does not require heating the disk.

### SUMMARY OF THE INVENTION

The invention is a magnetic recording system with a medium that includes a bilayer of a high-anisotropy recording layer and an exchange-coupled antiferromagnetic-to-ferromagnetic (AF-F) transition layer but that does not require heating of the medium. The transition layer has an AF-F transition temperature (T_{AF-F}) that decreases relatively rapidly with increasing applied magnetic field. Thus the transition layer has a transition field H_{AF-F}(T), which is the applied magnetic field that is required to cause a transition of the material from antiferromagnetic to ferromagnetic at temperature T without the need to heat the layer. In a disk drive implementation of the system, the disk drive has an operating temperature range between a low operating temperature T_{L} and a high operating temperature T_{H} and the transition layer has a T_{AF-F} greater than T_{H} in the absence of a write field H_{W} and a T_{AF-F} less than T_{L} in the presence of H_{W}. At ambient temperature and in the absence of H_{W}, the transition layer is antiferromagnetic and the switching field H₀ of the bilayer is just the H₀ of the high-anisotropy recording layer, which is typically much higher than H_{W}.

In the presence of the write field H_{W} the transition layer transitions from antiferromagnetic to ferromagnetic for all disk drive operating temperatures without the need to heat the transition layer. Data can be written to the recording layer in the conventional manner by the mere application of the write field H_{W} without the need to heat the transition layer or recording layer. In the presence of H_{W}, the transition layer becomes ferromagnetic so H₀ for the bilayer is reduced below H_{W} to enable writing to the recording layer.

The transition layer may be formed of Fe(RhM), where M is an element selected from V, Mn, Au and Ni.

For a fuller understanding of the nature and advantages of the present invention, reference should be made to the following detailed description taken together with the accompanying figures.

### BRIEF DESCRIPTION OF THE DRAWINGS

FIG. 1 is a sectional view of a disk usable with the disk drive of the present invention illustrating the transition layer and ferromagnetically-coupled recording layer.

FIG. 2 is a graph of transition temperature TAF-F as a function of Ir, Pt and Pd content for bulk Fe(Rh₁₋ₓMₓ)_{1.08} antiferromagnetic-to-ferromagnetic transition material.

FIG. 3 is a temperature-field antiferromagnetic-to-ferromagnetic phase diagram for a thin film of FeRh.

FIG. 4 is a schematic of a cross section of a perpendicular magnetic recording head and disk of the magnetic recording disk drive according to this invention.

### DETAILED DESCRIPTION OF THE INVENTION

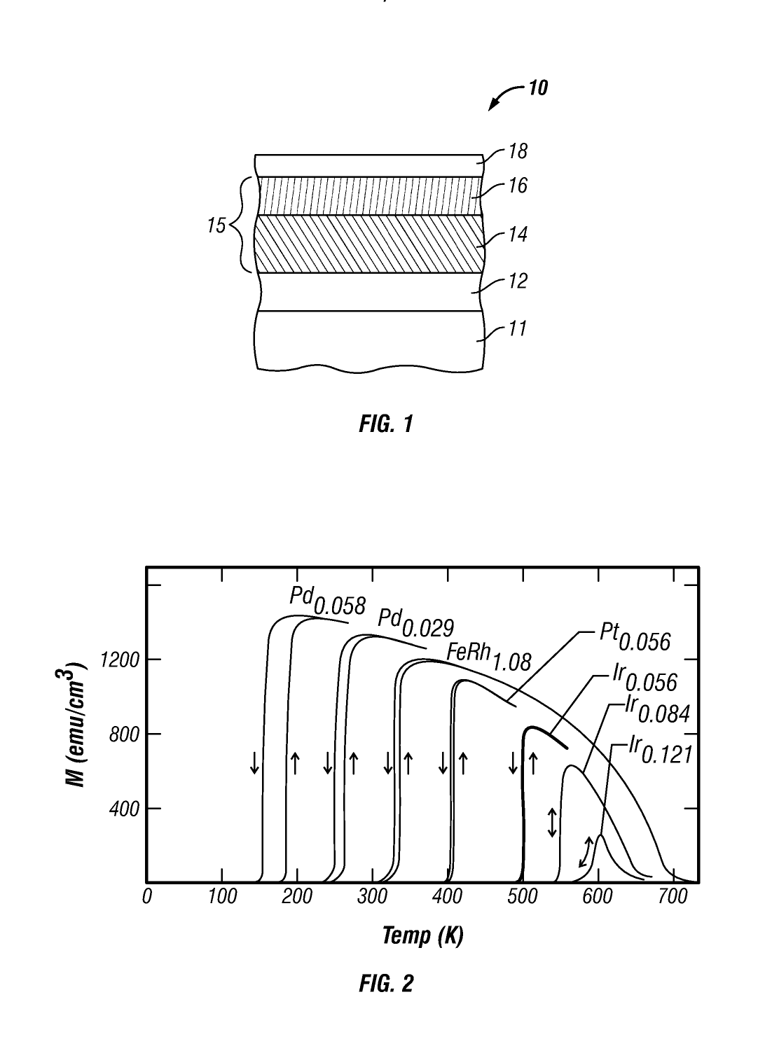

FIG. 1 shows a sectional view of the magnetic recording medium usable with the system of the present invention. The disk 10 is similar to the disk described in the previously-cited U.S. Pat. No. 6,834,026 B2, but in the disk drive implementation of this invention heating of the disk is not required. The disk comprises a substrate 11, an optional seed layer or underlayer 12, an antiferromagnetic-to-ferromagnetic (AF-F) transition layer 14, a high-anisotropy ferromagnetic recording or storage layer 16 on the transition layer 14, and a protective overcoat 18. The recording layer 16 is shown on top of the transition layer 14, but these two layers can be reversed with the recording layer being located between the substrate and the transition layer. The transition layer 14 and recording layer 16 are represented as a bilayer 15 because they are ferromagnetically exchange-coupled during writing, which is achieved by growing them in direct contact with each other. The optional seed layer 12 is used to enhance the growth of the layer immediately above it.

The recording layer 16 may be a material with horizontal magnetic anisotropy for horizontal recording, or a material with perpendicular magnetic anisotropy for perpendicular recording. If the disk is for perpendicular recording then the disk may include a “soft” or relatively low-coercivity magnetically permeable underlayer (SUL) below the transition layer/recording layer bilayer 15 and a nonmagnetic exchange break layer (EBL) between the SUL and the bilayer 15. The SUL serves as a flux return path for the field from the write pole to the return pole of the perpendicular recording head and the EBL breaks the magnetic exchange coupling between the magnetically permeable films of the SUL and the bilayer 15.

The disk substrate 11 may be any commercially available glass substrate, but may also be a conventional aluminum alloy with a NiP surface coating, or an alternative substrate, such as silicon, canasite or silicon-carbide. The overcoat 18 is typically diamond-like amorphous carbon, but may be any conventional disk overcoat or other known protective overcoat, such as silicon nitride (SiN). All of the layers 12, 14, 16 and 18 are deposited on the substrate 11 by conventional thin film deposition techniques, such as RF or DC magnetron sputtering, ion beam deposition, or molecular beam epitaxy.

The transition layer 14 is formed of an antiferromagnetic-to-ferromagnetic (AF-F) transition material that has a transition temperature T_{AF-F} slightly above the highest operating temperature T_{H} of the disk drive. The disk drive design specifications specify an operating range between a low temperature T_{L} and a high temperature T_{H}. Typical values of T_{L} and T_{H} are about 275 K and 330 K, respectively, for disk drives used in typical computer applications. FeRh or Fe(RhM) alloys are (AF-F) transition materials that have this property. They are substantially in the body-centered-cubic (bcc) phase and are substantially chemically-ordered. Thus the transition layer 14 is preferably formed of Feₓ(Rh_{100-y})₁₀₀₋ₓ, where the subscripts refer to atomic percent, 0≦y≦15, and the value of x is selected so that the Fe(RhM) (or FeRh if y=0) alloy is substantially in the bcc phase. In the chemically-ordered bcc structure Fe atoms occupy the cube corners and Rh atoms the cube centers. For Fe-rich alloys certain of the Rh atoms are substituted with Fe atoms, and for Rh-rich alloys certain of the Fe atoms are substituted with Rh atoms in the cubic structure. According to the phase diagram FcₓRh₁₀₀₋ₓ alloys exhibit a single bcc phase for 48.5≦x≦55, and a two-phase mixture of bcc and face-centered-cubic (fcc) for 33≦x≦48.5. Thus for the present invention it is believed that the FeRh or Fe(RhM) alloy will have a sufficient amount of bcc-phase material to exhibit the required antiferromagnetic-to-ferromagnetic transition if x is approximately in the range of 40≦x≦55. The FeRh or Fe(RhM) alloy becomes substantially chemically-ordered by deposition at an elevated temperature or by post-deposition annealing.

The transition temperature T_{AF-F} of the FeRh alloy can be increased or decreased by substituting a fraction of the Rh atoms with the third element M. FIG. 2 (reproduced from FIG. 1(a) in J. S. Kouvel, J. Appl. Phys. 37, 1257 (1966)) shows the magnetization vs. temperature curves (and thus the transition temperature T_{AF-F}) for bulk Fe(Rh₁₋ₓMₓ)_{1.08} single crystal samples, where M=Pt, Ir or Pd. As shown by FIG. 2, very small amounts of M have a significant affect on T_{AF-F}. Pt and Ir increase T_{AF-F}, with Ir having a significantly greater influence than Pt, while Pd decreases T_{AF-F}. Other elements such as V, Mn, Au, and Ni are known to decrease T_{AF-F} in bulk FeRh.

The ferromagnetic recording or storage layer 16 may be a high anisotropy material with a room-temperature coercivity so high that it is incapable of being written to by a conventional write head (i.e., its switching field H₀ is higher than the write field H_{W}). The recording layer material may be either a horizontal type recording material or a perpendicular type recording material.

One type of material for recording layer 16 is chemically-ordered FePt or CoPt (or FePd or CoPd) with its c-axis substantially out-of-plane for perpendicular recording or substantially in-plane for horizontal recording. Chemically-ordered alloys of FePt, CoPt, FePd, and CoPd (all ordered in L1₀) and CoPt₃, CoPd₃ (both ordered in L1₂) in their bulk form, are known for their high magneto-crystalline anisotropy and magnetic moment, properties that are desirable for high-density magnetic recording materials. These chemically-ordered films can be made by several known processes. Films having the L1₀ phase of FePt with the c-axis oriented out-of-plane or perpendicular to the substrate, and thus suitable for perpendicular magnetic recording media, have been grown onto a hot substrate by molecular beam epitaxy and by sputter deposition. They can also be formed by alternating the deposition of films of Fe and Pt, followed by annealing, the latter approach being described in U.S. Pat. No. 5,363,794. Chemically-ordered alloys of FePt and CoPt have also been proposed for horizontal magnetic recording media. For example, equiatomic FePt or CoPt can be sputter deposited as a continuous film and then subjected to a relatively high-temperature post-deposition annealing to achieve the chemical ordering. This approach results in the c-axis being oriented substantially in the plane of the film, so that the films are suitable for horizontal magnetic recording, as described by Coffey et al., “High Anisotropy L1₀ Thin Films for Longitudinal Recording”, IEEE Transactions on Magnetics, Vol. 31, No. 6, November 1995, pp. 2737-2739. In U.S. Pat. No. 6,086,974, a continuous granular film with grains of a chemically-ordered FePt or CoPt alloy in the tetragonal L1₀ structure and with the c-axis in the plane for horizontal magnetic recording, is produced by sputtering without annealing. Other high anisotropy materials suitable for the recording layer 16 include pseudo-binary alloys based on the FePt and CoPt L1₀ phase, i.e., FePt—X and CoPt—X, where the element X may be Ni, Au, Cu, Pd or Ag, as well as granular composite materials such as FePt—C, FePt—ZrO, FePt—MgO, FePt—B₂O₃ and other similar composites. While these materials in general have similarly high anisotropy as the binary alloy FePt and CoPt, they allow additional control over the magnetic and structural properties of the media. Other materials with perpendicular magnetic anisotropy include Co/Pt, Co/Pd, Fe/Pt and Fe/Pd multilayers. These multilayers provide the advantage that they can be processed at lower temperatures than the L1₀ phase materials, while offering relatively high magneto-crystalline anisotropy. Current horizontal magnetic recording disks use a recording layer of a granular CoPtCr alloy, such as CoPtCrB or CoPtCrTa. The anisotropy of this horizontal magnetic recording media can be raised to a level suitable for a high K_{U} layer by increasing the Pt content and decreasing the Cr content.

For thin FeRh films the T_{AF-F} decreases in the presence of an applied magnetic field and the gradient of this decrease is relatively large, i.e., approximately −8 Kelvin (K)/Tesla. This behavior is reversible, i.e., after the applied magnetic field is removed, the T_{AF-F} of the thin FeRh film is the same as before the application of the magnetic field. This is reported by the inventors in S. Maat, J.-U. Thiele, and Eric E. Fullerton, “Temperature and field hysteresis of the antiferromagnetic-to-ferromagnetic phase transition in epitaxial FeRh films”, Phys. Rev. B 72, 214432, Dec. 22, 2005.

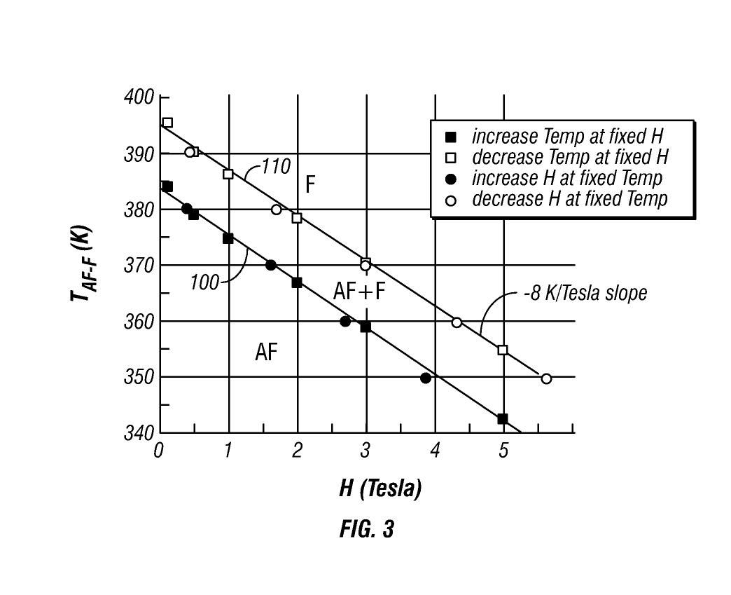

FIG. 3 is a temperature-field AF-F phase diagram for FeRh thin films. This data was obtained from a 110 nm thick Fe₄₉Rh₅₁ film sputter deposited from a FeRh alloy target at 2 mTorr pressure onto a single-crystal MgO substrate. After deposition the sample was annealed in situ at 800° C. for about 30 minutes to obtain the chemically-ordered bcc phase of FeRh. The phase diagram of FIG. 3 was determined from magnetization vs. temperature measurements in fixed fields and magnetization vs. field measurements at fixed temperatures for these samples.

FIG. 3 shows that the transition temperature T_{AF-F} of the FeRh film in the absence of a field (H=0) is approximately 395 K, as described in the previously-cited U.S. Pat. No. 6,834,026 B2. However, FIG. 3 also shows that in the presence of an applied field the T_{AF-F} is reduced at the rate of approximately −8 K/Tesla, corresponding to the slope of the lines 100, 110. (The spacing between parallel lines 100, 110 is a result of the field hysteresis and temperature hysteresis as temperature and field were increased and decreased during the measurements).

FIG. 3, particularly the relatively large −8 K/Tesla decrease of T_{AF-F,} has led to the realization that AF-F transition layers, formed of materials like FeRh and Fe(RhM), also have a transition field H_{AF-F}(T). The transition field H_{AF-F}(T) is the applied magnetic field that is required to transition the FeRh from the antiferromagnetic phase to the ferromagnetic phase at temperature T without the need to heat the layer. As shown in FIG. 3 H_{AF-F} decreases with increasing ambient temperature.

An extrapolation of the line 110 in FIG. 3 shows that for a Fe₄₉Rh₅₁ film on MgO, the value of H_{AF-F} (T_{AF-F} approximately 300 K) is approximately 12 Tesla. This field is well beyond the write field that can be achieved by current and advanced perpendicular write heads of approximately 2 Tesla or 2 kOe (1 Tesla=10 k Oe). However, it is well known that T_{AF-F} can be greatly reduced in bulk FeRh by the addition of small amounts of an additional element or elements, as shown in FIG. 2 by the addition of Pd to bulk FeRh. Thus, as can be appreciated from FIG. 3, an Fe(RhM) thin film with a T_{AF-F} of approximately 320 K in the absence of a field (a reduction of approximately 75 K by the addition of the M element or elements) would have an H_{AF-F} of approximately 2 Tesla, which is near a presently achievable write field. This assumes that the slope of line 110 is only −8 K/Tesla, but Fe(RhM) alloy layers or other AF-F transition layers may have phase diagrams with even greater negative slopes. This would allow use of Fe(RhM) with T_{AF-F} greater than 320 K for enhanced thermal stability. Other elements besides Pd that are known to lower T_{AF-F} in bulk FeRh are V, Mn, Au, and Ni.

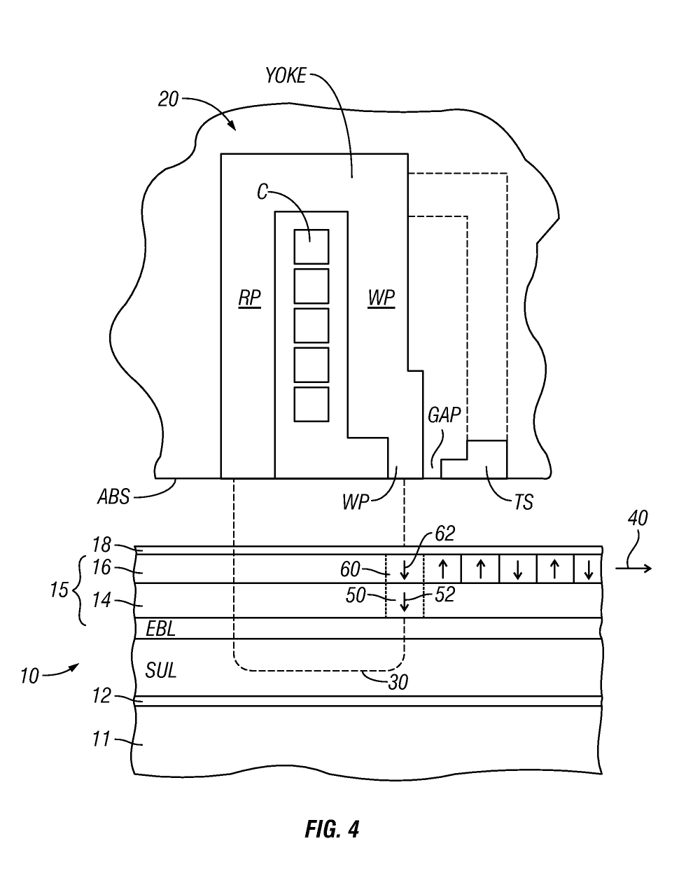

FIG. 4 is a schematic of a cross section of a perpendicular magnetic recording head and disk of the magnetic recording disk drive according to this invention. The disk 10 is the perpendicular magnetic recording embodiment of the disk 10 in FIG. 1 and thus includes the substrate 11, seed layer 12, the SUL located on seed layer 12, and the EBL on the SUL. The bilayer 15 of transition layer 14 and recording layer 16 are above the EBL and the protective disk overcoat 18 is on the bilayer 15.

The SUL may be a single layer of magnetically permeable material, as shown in FIG. 4. The SUL may also be a laminated or multilayered antiferromagnetically-coupled (AF-coupled) SUL formed of at least two soft magnetic films separated by a nonmagnetic interlayer film, such as an interlayer film of Ru, Ir, or Cr or alloys thereof, that mediates an antiferromagnetic coupling. This type of SUL is described in U.S. Pat. Nos. 6,686,070 B1 and 6,835,475 B2. However, instead of the AF-coupled SUL, the SUL may be a non-AF-coupled laminated or multilayered SUL that is formed of multiple soft magnetic films separated by nonmagnetic films, such as films of carbon or SiN or electrically conductive films of Al or CoCr. The SUL layer or layers are formed of magnetically permeable materials such as alloys of CoNiFe, FeCoB, CoCuFe, NiFe, FeAlSi, FeTaN, FeN, FeTaC, CoTaZr, CoFeTaZr, CoFeB, and CoZrNb.

The EBL is located on top of the SUL. It acts to break the magnetic exchange coupling between the magnetically permeable films of the SUL and the transition layer/recording layer bilayer. The EBL may not be necessary, but if used it can be a nonmagnetic titanium (Ti) layer; a non-electrically-conducting material such as Si, Ge and SiGe alloys; a metal such as Cr, Ru, W, Zr, Nb, Mo, V and Al; a metal alloy such as amorphous CrTi and NiP; an amorphous carbon such as CNx, CHx and C; or oxides, nitrides or carbides of an element selected from the group consisting of Si, Al, Zr, Ti, and B. If an EBL is used, a seed layer to assist the growth of the EBL may be deposited on top of the SUL before deposition of the EBL.

FIG. 4 shows the disk 10 with a recording head or write head 20 that uses a single write pole (WP). A thin film coil (C) is shown in section between the WP and the return pole (RP) of the recording head 20. The portion above the coil in FIG. 4 that connects the WP and the return pole is referred to as the yoke. The coil may also be wrapped helically around the write pole WP. Write current through coil C induces a magnetic field (shown by dashed line 30) from the WP that passes through the recording layer 16 and transition layer 14, through the flux return path provided by the SUL, and back to the RP. The recording head 20 is typically formed on an air-bearing slider that has its air-bearing surface (ABS) supported above the rotating disk 10. FIG. 4 also shows the recording head 20 having a trailing shield (TS) that is near the WP but spaced from the WP by a gap of nonmagnetic material. The TS may be connected to the yoke, as represented by the dashed lines between the TS and the yoke in FIG. 4, or to the RP, such as by side connections that would extend out of the paper in FIG. 4. The TS may also be “floating” as shown in FIG. 4, meaning that is not magnetically connected to either the yoke or the RP.

As shown in FIG. 4 the recording layer 16 is illustrated with perpendicularly recorded or magnetized regions along a data track, with adjacent regions having opposite magnetization directions, as represented by the arrows in recording layer 16. These regions are detected by the read head (not shown) as the recorded bits. In FIG. 4, the disk 10 moves past the recording head 20 in the direction indicated by arrow 40.

The transition layer 14 should have a transition temperature T_{AF-F} above the highest disk drive operating temperature T_{H}. This ensures that when the disk drive temperature is within its design operating temperature range, and in the absence of a write field H_{W} from the write head 20, the transition layer will be in its antiferromagnetic state. The transition layer material is selected so that its T_{AF-F} exceeds the low temperature T_{L} in the operating range by an increment ΔT. The increment ΔT is less than or equal to the amount T_{AF-F} is decreased when the transition layer 14 is exposed to the write field H_{W} from the write head 20. For example, if T_{L}=295 K and T_{H}=305 K, ΔT may be selected to be 15 K, which would result in selection of a transition layer material having T_{AF-F} of 310 K. Then assuming a −8 K/Tesla slope for the AF-F phase diagram for the transition layer material, a write field H_{W} of 2 Tesla (20 kOe) will reduce T_{AF-F} to 294 K, which is below T_{L}. Thus in the presence of the write field H_{W} the transition layer material will transition from antiferromagnetic to ferromagnetic for all operating temperatures without the need to heat the transition layer.

Thus in the disk drive of this invention data can be written to the recording layer 16 in the conventional manner by the mere application of the write field H_{W} without the need to heat the transition layer 14 or recording layer 16. In the presence of H_{W}, the transition layer 14 is ferromagnetic and the transition layer 14 and recording layer 16 are strongly exchange-coupled ferromagnetically. The switching field is given by the following equation:

H₀≈(K_{U-RL}*t_{RL})/(M_{RL}*t_{RL}+M_{TL}*t_{TL}), Equation 1

where RL represents recording layer, TL represents the transition layer, M is the moment and t is the thickness.

The recording of a data bit is depicted in FIG. 4 by region 50 of transition layer 14 and region 60 of recording layer 16 just below the WP of write head 20. In the presence of H_{W}, region 50 in transition layer 14 becomes ferromagnetic, as represented by arrow 52. The switching field H₀ (Equation 1) of the ferromagnetically exchange-coupled regions 50,60 is reduced below H_{W} because region 50 now possesses a moment M_{TL}. Thus region 60 in recording layer 16, which is strongly exchange-coupled ferromagnetically to region 50 in transition layer 14, becomes magnetized, as represented by arrow 62. After regions 50,60 have been exposed to the write field H_{W} from WP, they move past WP in the direction of arrow 40. The region 50 is no longer exposed to H_{W} and now becomes antiferromagnetic, but the bit pattern remains in the region 60 of the recording layer, as represented by the arrows in recording layer 16 downstream of the WP. At ambient temperature the switching field H₀ of the bilayer 15 is now much higher and is the H₀ of just the high anisotropy recording layer 16, according to the following equation:

H₀≈K_{U-RL}/M_{RL}. Equation 2

Thus the thermal stability of the high-anisotropy recording layer 16 at room temperature is greatly enhanced over conventional ferromagnetic layers which have a much lower switching field. The transition layer and recording layer layers need to be strongly ferromagnetically coupled, which is achieved by growing them in direct contact with each other.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A magnetic recording system comprising:
a write head for generating a magnetic write field (H_{W}); and
a magnetic recording medium comprising
a substrate;
an antiferromagnetic-to-ferromagnetic (AF-F) transition layer on the substrate and having a transition field (H_{AF-F}) less than H_{W}; and
a ferromagnetic recording layer in contact with the transition layer, the transition layer and recording layer being exchange-coupled ferromagnetically when the transition layer is in its ferromagnetic state after exposure to H_{W}.

2. The system of claim 1 wherein the transition layer comprises an alloy comprising Fe and Rh.

3. The system of claim 2 wherein the transition layer comprises Fe(RhM), where M is an element selected from the group consisting of Pd, V, Mn, Au, and Ni.

4. The system of claim 3 wherein the Fe(RhM) is Feₓ(Rh_{100-y}M_{y})₁₀₀₋ₓ, where y is between about 0 and 15, and x is between about 40 and 55.

5. The system of claim 1 wherein the operating temperature range of the system is between T_{L} and T_{H}, and wherein the transition layer has an AF-F transition temperature T_{AF-F} greater than T_{H} in the absence of H_{W} and a T_{AF-F} less than T_{L} in the presence of H_{W}.

6. The system of claim 1 wherein the transition layer is located between the substrate and the recording layer.

7. The system of claim 1 wherein the recording layer has horizontal magnetic anisotropy.

8. The system of claim 1 wherein the recording layer has perpendicular magnetic anisotropy.

9. The system of claim 1 wherein the recording layer comprises a chemically-ordered alloy selected from alloys of FePt, CoPt, FePd, CoPd, CoPt₃ and CoPd₃.

10. The system of claim 1 wherein the recording layer comprises a chemically-ordered L1₀ phase alloy selected from FePt—X and CoPt—X, where the element X is selected from the group consisting of Ni, Au, Cu, Pd and Ag.

11. The system of claim 1 wherein the recording layer comprises a multilayer selected from the group consisting of Co/Pt, Co/Pd, Fe/Pt and Fe/Pd multilayers.

12. The system of claim 1 further comprising a protective overcoat over the recording layer.

13. A magnetic recording disk drive having an operating temperature range between T_{L} and T_{H} and comprising:
a write head for generating a magnetic write field (H_{W}); and
a magnetic recording medium comprising
a substrate;
an antiferromagnetic-to-ferromagnetic (AF-F) transition layer on the substrate and having a transition field (H_{AF-F}) less than H_{W}, the transition layer having a transition temperature (T_{AF-F}) greater than T_{H} in the absence of H_{W} and a T_{AF-F} less than T_{L} in the presence of H_{W}; and
a ferromagnetic recording layer in contact with the transition layer, the transition layer and recording layer being exchange-coupled ferromagnetically when the transition layer is in its ferromagnetic state after exposure to H_{W}.

14. The disk drive of claim 13 wherein the transition layer comprises Fe(RhM), where M is an element selected from the group consisting of Pd, V, Mn, Au, and Ni.

15. The disk drive of claim 14 wherein the Fe(RhM) is Feₓ(Rh_{100-y}M_{y})₁₀₀₋ₓ, where y is between about 0 and 15, and x is between about 40 and 55.

16. The disk drive of claim 13 wherein the transition layer is located between the substrate and the recording layer.

17. The disk drive of claim 13 wherein the recording layer has horizontal magnetic anisotropy.

18. The disk drive of claim 13 wherein the recording layer has perpendicular magnetic anisotropy.

19. The disk drive of claim 13 wherein the recording layer comprises a chemically-ordered alloy selected from alloys of FePt, CoPt, FePd, CoPd, CoPt₃ and CoPd₃.

20. The disk drive of claim 13 wherein the recording layer comprises a chemically-ordered L1₀ phase alloy selected from FePt—X and CoPt—X, where the element X is selected from the group consisting of Ni, Au, Cu, Pd and Ag.

21. The disk drive of claim 13 wherein the recording layer comprises a multilayer selected from the group consisting of Co/Pt, Co/Pd, Fe/Pt and Fe/Pd multilayers.

22. The disk drive of claim 13 further comprising a protective overcoat over the recording layer.
